(19) United States
(12) Patent Application Publication
(10) Pub. No.: US 2009/0036177 A1
(43) Pub. Date: Feb. 5, 2009

(54) Hinge Device and Mobile Terminal Having the Same

(76) Inventors: Ul-Ho Lee, Gyeonggi-do (KR); Yong-Jae Kim, Gyeonggi-do (KR)

Correspondence Address: HARNESS, DICKEY & PIERCE, P.L.C., P.O. BOX 8910, RESTON, VA, 20195, US

(21) Appl. No.: 11/922,919

(22) PCT Filed: Sep. 26, 2005
(86) PCT No.: PCT/KR2005/003192

§ 371 Date: Sep. 30, 2008

(30) Foreign Application Priority Data
Jun. 27, 2005 (KR) 10-2005-0055488

(51) Int. Cl. H04M 1/00; H04B 1/38

(52) U.S. Cl. 455/575.3; 361/814

(57) ABSTRACT

A hinge device and a mobile terminal having the hinge device are described. The hinge device of mobile terminal having folder and main body involves the first hinge part having the first hinge axis which enables the folder to rotate to open the front of the main body, the second hinge part having the second hinge axis which connected to the side of the first hinge axis and enables the folder to swivel and a slide part which connected to the first hinge axis or the second hinge axis and guide the folder to slide with respect to main body. The mobile terminal having the hinge device may have a decreased volume, convenience of portability and use as well as a sightly appearance.

### TECHNICAL FIELD

This document relates to a hinge device and a mobile terminal having the same, more particularly, the hinge device and mobile terminal utilizing the same which allows a folder to rotate and slide.

### BACKGROUND ART

As mobile terminals such as mobile phone and PDA equips with a camera and a camcoder, the swivel hinge is being widely used, which allows folder on a wide screen by rotating the folder and fitting it to the main body. Especially, with the wide-spread use of digital multimedia broadcasting (“DMB”) the demands to fit the folder to the main body for long time use is increasing. And the demand for keys enable to perform various complicated functions is also caused due to the addition of multimedia functions to the mobile terminal, which brings a burden on the design state of implementing extra keys.

FIG. 1 is a perspective view of a mobile terminal having a conventional concentric swivel hinge and FIG. 2 is a perspective view illustrating the state wherein the folder is rotated and fitted to the main body.

Referring to FIG. 1, a mobile terminal having a swivel hinge comprises a folder 1 having an inner display screen 2 and a main body 3 having a plurality of keys 4 and coupled to the folder 1 by a swivel hinge 6. The folder 1 may open or close with the main body 3 by a rotation hinge 5 formed on the upper part of the main body 3. The swivel hinge 6 projected perpendicularly to one side of the rotation hinge 5 is coupled with the folder 1 and the folder is rotated 180 by the swivel hinge 6. When the folder is rotated 180° the folder is fitted to the main body 3 with the inner display screen 2 exposed to the exterior.

As shown in FIG. 2, the folder 1 is rotated symmetrically with respect to a central axis X and superposed completely to the main body 3. Therefore, for the conventional mobile terminal shown in FIGS. 1 and 2, the keys 4 formed on the main body 3 can not be used which causes to implement extra keys.

Conventional mobile terminals having an eccentric swivel hinge to expose a portion of keys when the folder is rotated are shown in FIGS. 3 and 4 in order to resolve the problem, which the keys are not positioned to be used when the folder and the main body are superposed.

FIG. 3 is a perspective view of a mobile terminal having a conventional eccentric swivel hinge and FIG. 4 is a perspective view illustrating the state wherein the folder is fitted to the main body.

For the mobile terminal having an eccentric swivel hinge shown in FIGS. 3 and 4, the folder 1 is asymmetrically rotated by means of a swivel hinge and superposed to the main body 3. Thus, as shown in FIG. 4, a portion of the keys 4 on the main body 3 is exposed to the exterior.

However, with such a portable terminal having an eccentric swivel hinge, as shown in FIG. 4, the shape of the terminal is asymmetrically formed when it used with the inner display screen 2 exposed to the exterior, making it unsightly in appearance. Also, since the asymmetrical portion leads to a corresponding increase in size, there is the problem that the use and carriage of the terminal is made inconvenient when the use of the keys 4 is not needed.

### DISCLOSURE OF INVENTION

### Technical Problem

The present invention has been developed to solve the forgoing problems, and it is therefore an objective of the present invention to provide a hinge device and a mobile terminal having the hinge device of which the keys on the main body may be used by rotating the folder by a predetermined angle when the main body and the folder are superposed with the inner surface of the folder exposed to the exterior.

### Technical Solution

A hinge device according to an embodiment of the invention comprises: a first hinge part having a first hinge axis which can be a central axis of rotation to open or close the front surface of the main body, a second hinge part having a second hinge axis which is connected to one side of the first hinge axis and enables the folder 180 rotation, and a slide part which is connected to the first hinge axis or the second hinge axis and guides the folder to slide with respect to main body. Because the present invention allows the use of the inner display screen of the folder exposed to the exterior and the use of the keys on the main body by sliding the folder as needed.

The slide part may comprise a guide part and a guide member inserted into and guided by the guide part. And the guide member may be coupled to the second axis. The guide part may be formed at the lower surface of the folder or the first hinge part.

The second hinge part may further comprise a swivel projection part or a swivel groove part to support the second axis rotatably. The swivel projection part or the swivel groove part may be formed at the lower surface of the folder or the first hinge axis.

A mobile terminal according to another embodiment of the invention comprises: a folder, a main body, a first hinge part having a first hinge axis which enables the folder to rotate to open or close the front surface of the main body, a second hinge part having a second hinge axis which is connected to one side of the first hinge axis and enables the folder 180° rotation, and a slide part which is connected to the first hinge axis or the second hinge axis and guides the folder to slide with respect to main body.

The slide part may comprise a guide part and a guide member inserted into and guided by the guide part. And the guide member may be coupled to the second axis.

The guide part may be formed at the lower surface of the folder or the first hinge part. The second hinge part may further comprise a swivel projection part or a swivel groove part to support the second axis rotatably. In addition, the swivel projection part or the swivel groove part may be formed at the lower surface of the folder or the first hinge axis.

### BRIEF DESCRIPTION OF THE DRAWINGS

The accompanying drawings, which are incorporated in and constitute a part of the specification, illustrate embodiments of the invention, and together with the general description given above and the detailed description of the embodiment given below, serve to explain the principles of the invention.

FIG. 1 is a perspective view of a mobile terminal having a conventional swivel hinge.

FIG. 2 is a perspective view of the mobile terminal of FIG. 1 illustrating the state wherein the folder is rotated and fitted to the main body.

FIG. 3 is a perspective view of a mobile terminal having a conventional eccentric swivel hinge.

FIG. 4 is a perspective view of the mobile terminal of FIG. 3 illustrating the state wherein the folder is rotated and fitted to the main body.

FIG. 5 is a perspective view of the hinge device according to an embodiment of the invention.

FIG. 6 is a sectional view of the combined hinge device illustrated in FIG. 5.

FIG. 7 is a perspective view of the hinge device according to another embodiment of the invention.

FIG. 8 is a sectional view of the combined hinge device illustrated in FIG. 7.

FIG. 9 is a perspective view of the hinge device according to another embodiment of the invention.

FIG. 10 is a sectional view of the combined hinge device illustrated in FIG. 9.

FIG. 11 is a perspective view of the hinge device according to another embodiment of the invention.

FIG. 12 is a sectional view of the combined hinge device illustrated in FIG. 11.

FIG. 13 is a perspective view of a mobile terminal having the hinge device according to an embodiment of the invention.

FIG. 14 is a perspective view illustrating the state wherein the folder is rotated and fitted to the main body.

FIG. 15 is a perspective view illustrating the state wherein the folder is rotated and fitted to the main body.

FIG. 16 is a perspective view illustrating the state wherein a portion of the keys is exposed by sliding the folder.

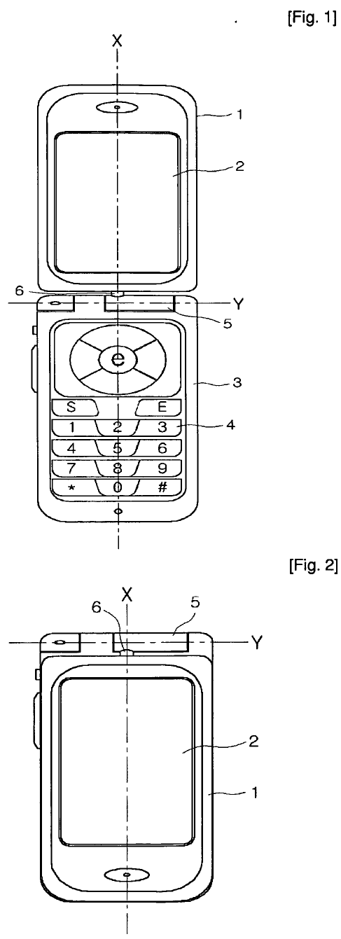

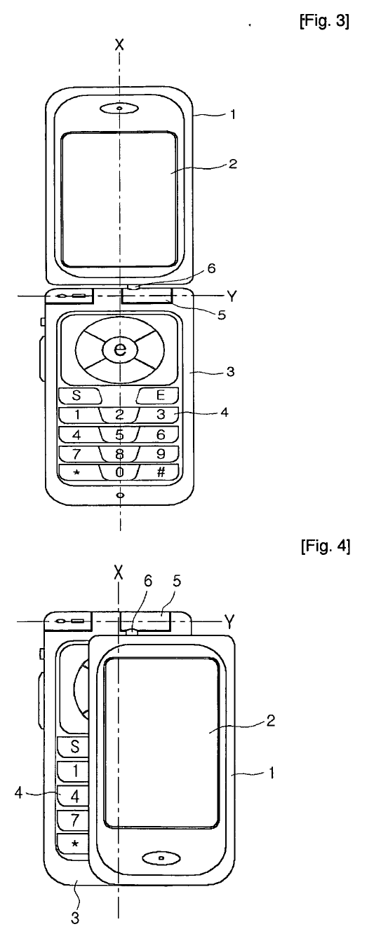

### BEST MODE FOR CARRYING OUT THE INVENTION

Hereinafter, embodiments of the invention will be described in more detail, where in the description with reference to the accompanying drawings those components are rendered the same reference number that are the same or are in correspondence regardless of the figure number, and redundant explanations are omitted.

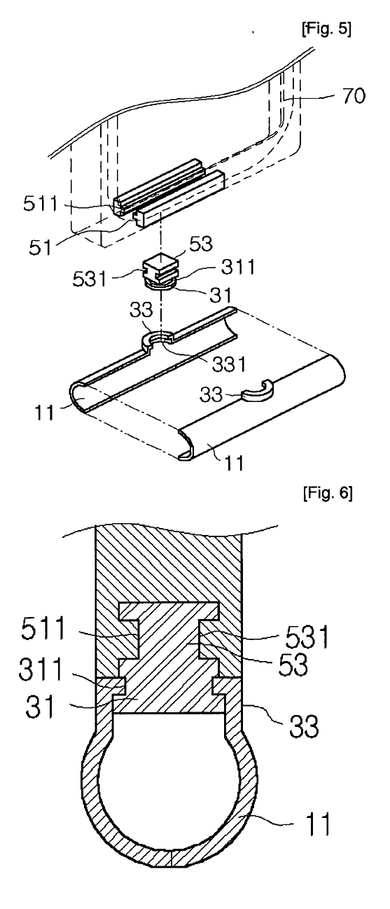

FIG. 5 is a perspective view of the hinge device according to an embodiment of the invention. Referring to FIG. 5, the hinge device according to an embodiment of the invention comprises a first hinge part having a first hinge axis 11 and a hinge arm (not illustrated), a second hinge part having a second hinge axis 31 and a swivel projection part 33, and a slide part having a guide part 51 and a guide member 53.

The first hinge part comprises the first hinge axis 31 and the hinge arm which rotatably supports the folder 70 to open or close the front surface of the main body.

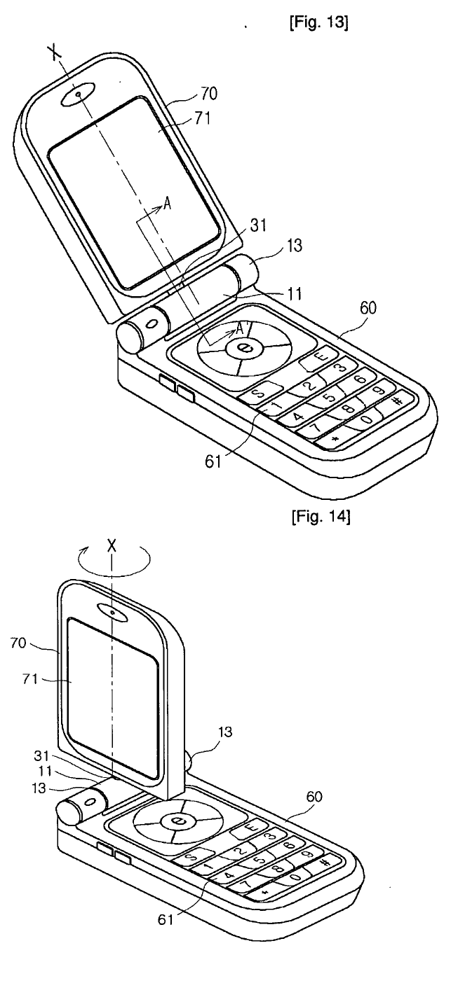

The first hinge axis 11 is a central axis of the rotation of the folder 70 and has a cylindrical shape having certain length and diameter. Because one or both ends of the first hinge axis 11 are fitted with the hinge arm (13 in FIG. 14), the folder 70 can be rotated about the hinge axis 11. The swivel projection part 33 is formed perpendicularly to the direction extending along the first hinge axis 11 and the swivel projection part 33 is joined with the hinge axis 31.

As illustrated in FIG. 14, the hinge arm 13 is positioned on the upper part of the main body and joined with one or both ends of the first hinge axis 11. The hinge arm 13 may be also positioned in the folder 70 as well as the main body.

The second hinge part is formed perpendicularly to the direction extending along the first hinge axis 11 on the center-line of the main body and comprises the second hinge axis 31 which supports the folder to allow 180° rotation and the swivel projection part 33 into which the second hinge axis 31 is rotatably inserted. The folder thus is rotated 180 by the second hinge part.

The second hinge axis 31, as shown in FIG. 5, is bush shaped. The guide member 53 is attached to the upper end of the second hinge axis 31. A swivel protrusion 331 is inserted into a groove 311 formed between the guide member 53 and the second hinge axis 31. The second hinge axis 31 is a rotation axis about which the folder 70 rotates 180° and rotates with the folder 70.

The swivel projection part 33 is projected perpendicularly to the direction extending along the first hinge axis 11 and has a cylindrical shape. In addition, the swivel protrusion 331 is projected inwardly along the circumference in the inner perimeter surface of the swivel projection part 33 and inserted into the groove 311 of the second hinge axis 31. The swivel projection part 33 is positioned on the centerline of the main body 60. Therefore, the folder 70 is symmetrically rotated by means of the swivel projection part 33.

The slide part enables the folder 70 to slide in a direction extending along the first hinge axis 11 and comprises a guide part 51 and a guide member 53.

The guide part 51 is formed on the lower surface of the folder 70 and the centerline thereof may be in alignment with or formed eccentrically to the one end from the centerline of the folder 70. On inner side of the guide part 51, a slide protrusion 511 is formed in a direction parallel to the first hinge axis 11. The slide protrusion 511 is inserted into the guide groove 531 of the guide member 53 and thus the guide member 53 can slide left and right in the guide groove 531. Accordingly, the length of the guide part 51 is substantially same with the sliding length of the folder 70.

The guide member 53 is I-beam shaped and combined with the upper end of the second hinge axis 31. The guide groove 531 is formed at both sides of the guide member 53 into which the slide protrusion 511 is inserted.

In this embodiment, the guide part 51 has the slide protrusion 511 and guide member 53 has the guide groove 531 and vice versa. Namely, the guide part 51 may have the guide groove 531 and guide member 53 may have the slide protrusion 511.

FIG. 6 is a sectional view of the combined hinge device illustrated in FIG. 5.

Referring to FIG. 6, the second hinge axis 31 and the guide member 53 combined with the supper surface of the second hinge axis 31 connect the folder 70 to the first hinge axis 11. The swivel protrusion 331 of the swivel projection part 33 is inserted into the groove 311 of the second hinge axis 31 and the slide protrusion 511 of the slide part 51 is inserted into the guide groove 531 of the guide member 53. Consequently, the second hinge axis 31 is a rotation axis of the folder 70 to rotate 180 and the guide member 53 enables the folder to slide as far as the length of the guide part 51 in a direction extending along the first hinge axis 11.

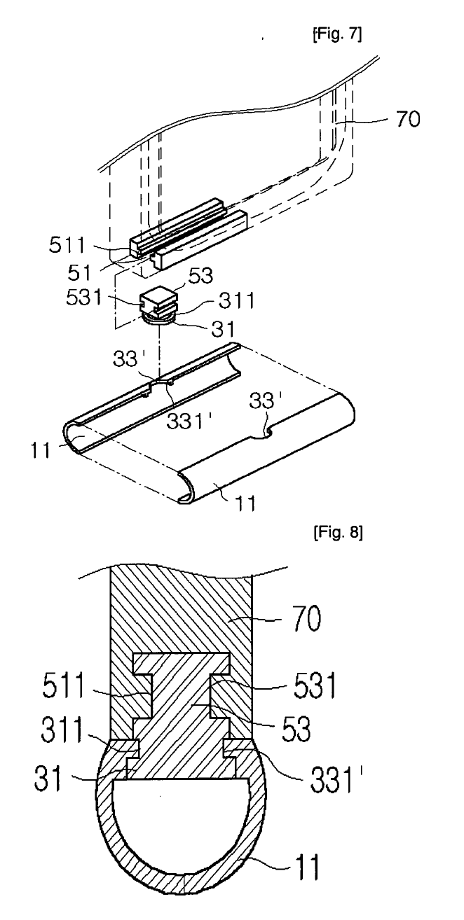

The embodiment illustrated in FIG. 7 has identical structure to the embodiments illustrated in FIG. 5 and FIG. 6 except that a swivel groove part 33 is formed on the first hinge axis 11 instead of the swivel projection part 33.

The swivel groove part 33 is a groove formed in a particular position of the first hinge axis 11 and a swivel protrusion 331 is formed therein. The second hinge axis 31 is inserted into the swivel groove part 33 and the swivel protrusion 331 is inserted into the groove 311 of the second hinge axis 31.

Referring to FIG. 8, the second hinge axis 31 and guide member 53 combined to the upper surface of the second hinge axis 31 connect the folder 70 to the first hinge axis 11. The swivel protrusion 331 of the swivel groove part 33 is inserted into the groove 311 of the second hinge axis 31 and the slide protrusion 511 is inserted into the guide groove 531 of the guide member 53. Therefore, the second hinge axis 31 is a rotation axis of the folder 70 to rotate 180 and the guide member 53 enables the folder 70 to slide in a direction extending along the first hinge axis 11.

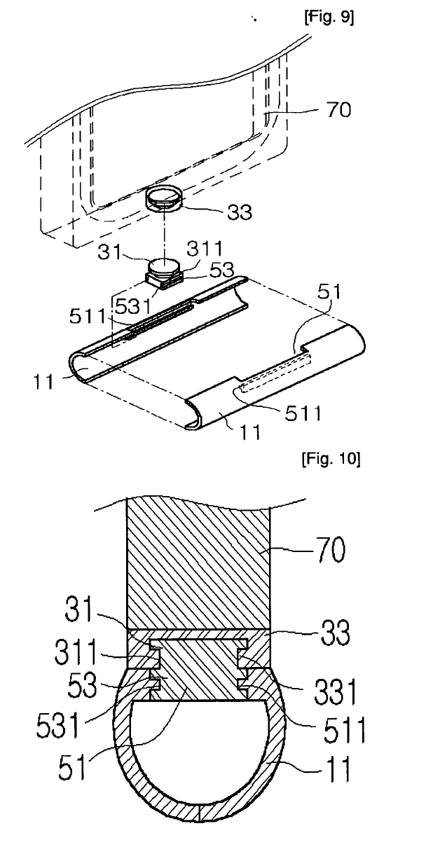

The embodiment illustrated in FIG. 9 has an identical structure to the embodiments illustrated in FIG. 5 and FIG. 6 except that the guide part 51 is formed on the first hinge axis 11 and the swivel projection part 33 is formed on the lower side of the folder 70. In addition, the second hinge axis 31 and the guide member 53 are positioned in an opposite direction to that of FIG. 5 in order to be fitted with the swivel projection part 33 and the guide part 51.

Referring to FIG. 10, the guide member 53 is inserted into the guide part 51 formed in the first hinge axis 11 and the guide protrusion 511 is inserted into the guide groove 531. Besides, while the second hinge axis 31 is inserted into the swivel projection part 33 formed in the lower surface of the folder 70, the swivel protrusion 331 is inserted into the groove 311. Consequently, the second hinge axis 31 enables the folder 70 to allow 180 rotations and the guide member 53 is connected to the second hinge axis 31 and enables the folder 70 to slide in a direction extending along the first hinge axis 11.

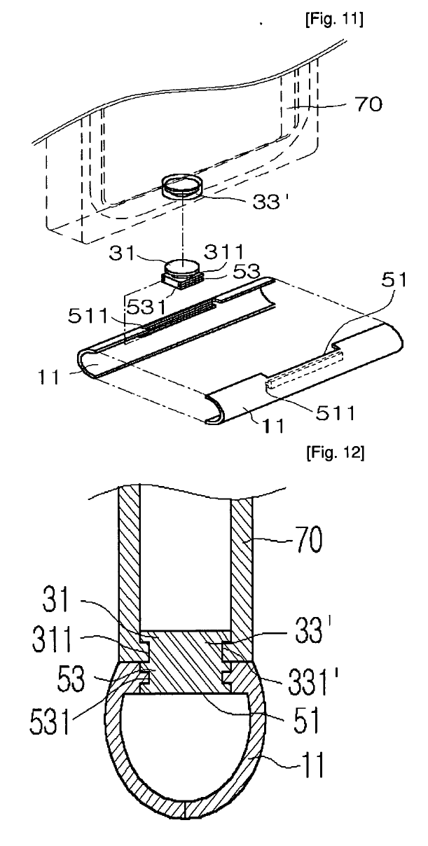

The embodiment of FIG. 11 has an identical structure to the embodiments of FIG. 9 except that, instead of the swivel projection part 33 illustrated in FIG. 9, a swivel groove part 33 is formed on the lower side of the folder 70. The swivel groove part 33 is in alignment of the centerline of the main body 60 and the folder 70.

Referring to FIG. 12, the second hinge axis 31 is rotatably inserted into the swivel groove part 33 formed in the lower side of the folder 70. In addition, the guide member 53 is inserted into the guide part 51 formed perpendicularly to the direction extending along the first hinge axis 11. Therefore, the second axis 31 enables the folder 70 to allow 180 rotation and the guide part 51 and guide member 53 enables the folder 70 to slide in the direction extending along the first hinge axis 11.

Referring to FIG. 13, both ends of the first hinge axis 11 are rotatably inserted into the hinge arm 13 so that the first hinge axis 11 becomes a rotation axis while the folder 70 opens or closes. The second hinge axis 31 is formed on one end of the first hinge axis 11 and positioned on the centerline X of folder 70 and the main body 60. The folder 70 has an inner display screen 71 and the main body 60 has a plurality of keys 61.

Referring to FIG. 14, the second axis 31 formed on one end of the first hinge axis 11 becomes a rotation axis of the folder and enables the folder 70 to allow 180 rotation. Because the second axis 31 is in alignment with the centerline of the folder 70 and main body 60, the folder 70 is symmetrically rotated left and.

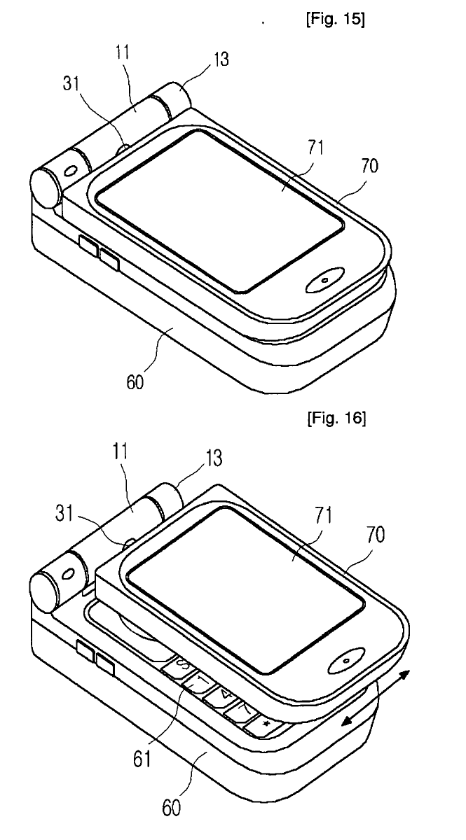

Since the second hinge axis 31 which is a rotation axis of the folder 70 is positioned on the centerline X of the folder 70 and the main body 60 as seen in FIG. 15, the folder 70 can be superposed to the main body 60 with the inner display screen 71 of the folder exposed to the exterior. The hem of the folder 70 is substantially in line with that of the main body 60. As a result, the keys 61 located on the front surface of the main body 60 are covered by the folder 70.

When the inner display screen 71 is used for a long time, for example to watch digital multimedia broadcasting and so on, since it can be used in the state wherein the folder 70 is completely fitted to the main body 60, the mobile terminal is convenient to use and carry as well as reduced in size.

Referring to FIG. 16, the folder 70 is connected to the first hinge axis 11 by the second hinge axis 31 and the guide member 53. The guide member 53 is inserted for the folder 70 being enabled to slide into the guide groove 51 (not shown) formed on the lower surface of the folder 70. Accordingly, to use the keys 61 while watching the inner display screen 71 exposed to the exterior, a user can expose the keys 61 by sliding a folder 70 (as is indicated by arrows).

Since the keys 61 formed on the main body can be used by means of sliding the folder 70, as needed, it is not necessary to have additional function keys to the mobile terminal. The keys 61 exposed to the exterior by sliding the folder 70 can be designed to have different functions from their original functions when the inner display screen 71 is exposed to the exterior.

Although the foregoing description details various embodiments of the invention, it will be appreciated that the embodiments are only examples of realizing the spirit of the invention, and that any changed or modified examples remain within the scope of the invention so long as they do not depart from the spirit of the invention.

### INDUSTRIAL APPLICABILITY

The invention provides a hinge device and a mobile terminal having the same that is convenient to use and carry and is sightly in appearance, as the keys attached to the main body may be used by sliding the folder by a predetermined angle when the folder is fitted to the main body with the inner display screen exposed to the exterior

1. A hinge device of a mobile terminal having a folder and a main body comprising:
a first hinge part having a first hinge axis about which the folder rotates to open or close the front surface of the main body;
a second hinge part having a second hinge axis which is connected to one side of the first hinge axis and allows the folder 180° rotation; and
a slide part which is connected to the first hinge axis or the second hinge axis and guides the folder to slide with respect to the main body.

2. The hinge device according to claim 1, wherein the slide part comprises a guide part and a guide member inserted into and guided by the guide part, and the guide member is connected to the second hinge axis.

3. The hinge device according to claim 2, wherein the guide part is formed in the folder.

4. The hinge device according to claim 2, wherein the guide part is formed in the first hinge part.

5. The hinge device according to claim 1, wherein the second hinge part further comprises a swivel projection part or a swivel groove part which rotatably supports the second hinge axis.

6. The hinge device according to claim 5, wherein the swivel projection part or the swivel groove part is formed on the lower surface of the folder.

7. The hinge device according to the claim 5, wherein the swivel projection part or the swivel groove part is formed on the first hinge axis.

8. A mobile terminal having folder and main body comprising:
a first hinge part having a first hinge axis about which the folder rotates to open or close the front surface of the main body;
a second hinge part having a second hinge axis which is connected to one side of the first hinge axis and allows the folder 180° rotation; and
a slide part which is connected to the first hinge axis or the second hinge axis and guides the folder to slide with respect to main body.

9. The mobile terminal according to claim 8, wherein
the slide part comprises a guide part and a guide member inserted into and guided by the guide part, and
the guide member is connected to the second hinge axis.

10. The mobile terminal according to claim 9, wherein the guide part is formed in the folder.

11. The mobile terminal according to the claim 9, wherein the guide part is formed in the first hinge part.

12. The mobile terminal according to claim 8, wherein the second hinge part further comprises a swivel projection part or a swivel groove part which rotatably supports the second hinge axis.

13. The mobile terminal according to claim 12, the swivel projection part or the swivel groove part is formed in the lower surface of the folder.

14. The mobile terminal according to claim 12, wherein the swivel projection part or the swivel groove part is formed on the first hinge axis.
